(19) United States
(12) Patent Application Publication
(10) Pub. No.: US 2012/0121980 A1
(43) Pub. Date: May 17, 2012

(54) ALKALINE STORAGE BATTERY ELECTRODE AND ALKALINE STORAGE BATTERY

(76) Inventor: Kimihiro Imamura, Kanagawa (JP)

(21) Appl. No.: 13/386,577

(22) PCT Filed: Apr. 8, 2011
(86) PCT No.: PCT/JP2011/002110

§ 371 Date: Jan. 23, 2012

(30) Foreign Application Priority Data
Apr. 9, 2010 (JP) 2010-090455
Dec. 17, 2010 (JP) 2010-282221

(51) Int. Cl. H01M 4/24; H01M 10/24

(52) U.S. Cl. 429/211

(57) ABSTRACT

An alkaline storage battery electrode includes a conductive core member as a current collector. A plurality of through holes are formed in the core member so as to be arranged linearly in parallel with a longitudinal direction of the core member. Each of the through holes has a substantially rectangular shape. The through holes are arranged so as to be shifted in the longitudinal direction of the core member at each of lines of the linearly-arranged through holes. A displacement amount between the through holes of adjacent lines in a width direction is less than a half of a sum of a size of the through hole in the longitudinal direction of the core member and a distance between the adjacent through holes in the longitudinal direction of the core member.

### TECHNICAL FIELD

The present invention relates to an alkaline storage battery electrode for use in an alkaline storage battery and the alkaline storage battery using the same.

### BACKGROUND ART

In recent years, in association with the rapid spread of electric cars in addition to information devices such as cellular phones, PHS and notebook computers, a secondary battery which has high added value, which can be reduced in size and weight and which has a high energy density is newly developed. Under such circumstances, there is a need in the market for batteries with more reduced size and higher capacity. Particularly, in an alkaline storage battery, there is a problem of how to increase a volume ratio of active material in a limited capacity.

In general, a negative electrode plate, which includes a core member coated with an active material, is used in an alkaline storage battery. FIG. 19 is a developed view of core member used in an electrode for an alkaline storage battery of related art. For a core member 57 of a negative electrode, punching metal is used. The punching metal is a nickel-plated steel sheet including a plurality of round through holes 58. Active material arranged on front and rear surfaces of the punching metal continues by way of the through holes 58. The through holes 58 are arranged on the core member 57 along longitudinal and width directions thereof so as to form a staggered pattern. The alkaline storage battery is produced by: laminating the negative electrode plate using the core member 57 and a positive electrode plate with a separator being sandwiched therebetween, and spirally rolling the laminated plates; storing the rolled plates concentrically in a cylindrical case; and filling the cylindrical case with an electrolyte of potassium hydroxide or the like. The active material of the negative electrode includes cadmium in the case of a nickel-cadmium storage battery. The active material of the negative electrode includes a hydrogen absorbing alloy in the case of a nickel-metal hydride storage battery.

In order to increase the volume ratio of the active material of the negative electrode plate of the alkaline storage battery, means for pressing the plate with a high pressure after having coated with paste containing the active material or means for increasing an aperture ratio in the core member thereby reducing a ratio of the core member in the negative electrode plate is experimented with. However, the excessive pressing increases warping in the electrode thereby deteriorating the processing property. Further, the excessive increase in the aperture ratio reduces the strength of the electrode and also causes an increase in electrical resistance due to the reduction of the core member portions through which electrons flow.

In order to solve such the problem, there has been proposed a method in which each of the through holes of the core member is formed in an substantially rectangular shape, and the through holes are disposed linearly with a predetermined distance therebetween along the longitudinal direction of the core member, which improves tensile strength of the core member so as to be durable against the pressing with a high pressure, thereby improving the volume ratio of the active material (see Patent Document 1).

In Patent Document 2, in order to improve the internal resistance of a battery, the substantially rectangular through hole formed in a core member is configured such that the size of the through hole in a lateral direction of the core member equals to or longer than the size of the through hole in a longitudinal direction of the core member. In Patent Document 3, substantially rectangular through holes are arranged linearly in parallel with the longitudinal direction of core member so as to satisfy a relation of 0.2b≦y≦0.5b, where “b” is the length of the through hole in the longitudinal direction of the core member and “y” is an interval between the through holes in the longitudinal direction of the core member. With this configuration, it is possible to improve the volume ratio of the active material in a structure durable against the pressing with a high pressure and also to minimize leakage defects caused by the core member structure when the core member is spirally rolled.

### RELATED ART DOCUMENTS

### Patent Documents

Patent Document 1: JP-A-2002-343366
Patent Document 2: JP-A-2009-117243
Patent Document 3: JP-A-2008-251199

### SUMMARY OF THE INVENTION

### Problem to be Solved by the Invention

In the related art described in Patent Documents 1 to 3, the substantially rectangular through holes are arranged such that the positions of the sides of the through holes which extend perpendicular to the longitudinal direction of the core member coincide with each other at every other line or at adjunct lines. Thus, when the electrode is rolled around a rolling core placed in a direction perpendicular to the longitudinal direction of the core member, a defect such as cracking or bending may occur at the electrode in the vicinity of the rolling core having a small curvature around the sides of the each through hole in parallel to the rolling core, which leads to a problem of dropping of the active material.

This invention is made in view of the above-described circumstances, and an object thereof is to improve the volume ratio of active material in an electrode and reduce the reactive resistance of the battery thereby achieving the battery of a high power, and also to suppress dropping of the active material at the time of rolling or laminating the electrode thereby achieving the battery with a long life time.

### Means for Solving the Problem

The present invention provides an alkaline storage battery electrode including a conductive core member as a current collector, wherein a plurality of through holes are formed in the core member so as to be arranged linearly in parallel with a longitudinal direction of the core member, wherein each of the through holes has a substantially rectangular shape, wherein the through holes are arranged so as to be shifted in the longitudinal direction of the core member at each of lines of the linearly-arranged through holes, and wherein a displacement amount between the through holes of adjacent lines in a width direction is less than a half of a sum of a size of the through hole in the longitudinal direction of the core member and a distance between the adjacent through holes in the longitudinal direction of the core member.

The present invention also includes the alkaline storage battery electrode, wherein the displacement amounts of the through holes have displacement amounts in one direction of the longitudinal direction of the core member.

The present invention also includes the alkaline storage battery electrode, wherein the displacement amounts of the through holes have displacement amounts in both directions of the longitudinal direction of the core member.

The present invention also includes the alkaline storage battery electrode, wherein the through holes are arranged such that in the width direction of the core member, the number of the displacement amount in a first direction along the longitudinal direction of the core member is the same as that in a second direction along the longitudinal direction of the core member.

The present invention also includes the alkaline storage battery electrode, wherein the through holes are arranged such that a function representing the displacement amount along the longitudinal direction of the core member has an inflection point on a way in the width direction of the core member.

The present invention also includes the alkaline storage battery, wherein the displacement amounts of the through holes in the longitudinal direction of the core member are constant irrespective of positions of the lines of the through holes in the width direction of the core member.

The present invention also includes the alkaline storage battery, wherein the displacement amount of the through holes in the longitudinal direction of the core member changes depending on a position of the line of the through holes in the width direction of the core member.

The present invention also includes the alkaline storage battery electrode, wherein 0.067≦x/(a+b)≦0.433 is satisfied, where “a” is a size of the through hole in the longitudinal direction of the core member, “b” is a distance between the adjacent through holes, and “x” is the displacement amount of the through holes.

The present invention also includes the alkaline storage battery electrode, wherein an aperture ratio of the through holes is set in a range of 20 to 61%.

The present invention also includes an alkaline storage battery including: an electrode group in which a negative electrode plate and a positive electrode plate with a separator being sandwiched therebetween are cylindrically rolled; and an electrolyte, wherein any one of the above-described alkaline storage battery electrodes is used as the positive electrode plate or the negative electrode plate.

With the above-described configurations, it is possible to prevent occurrence of cracking or bending of the electrode and to suppress dropping of the active material at the rolling of the electrode. Consequently, the life time of the battery can be extended. Further, it is possible to reduce the reaction resistance of the alkaline storage battery. Consequently, it is possible to increase an energy density.

The present invention also includes an alkaline storage battery including: an electrode group in which a negative electrode plate and a positive electrode plate with a separator being sandwiched therebetween are cylindrically laminated; and an electrolyte, wherein any one of the above-described alkaline storage battery electrode is used as the positive electrode plate or the negative electrode plate.

With the above-described configurations, it is possible to prevent occurrence of cracking or bending of the electrode and to suppress dropping of the active material at the lamination of the electrode. Consequently, the life time of the battery can be extended. Further, it is possible to reduce the reaction resistance of the alkaline storage battery. Consequently, it is possible to increase an energy density.

### ADVANTAGES OF THE INVENTION

According to the present invention, the core member durable against the pressing process with a high pressure is used for the electrode for the alkaline storage battery, whereby the volume ratio of the active material can be improved by utilizing. Further, since the reaction resistance of the alkaline storage battery can be reduced, the alkaline storage battery having a high energy density can be achieved. Furthermore, the dropping of the active material at the time of rolling or laminating the electrodes can be suppressed whereby the life time of the battery can be elongated.

### BRIEF DESCRIPTION OF THE DRAWINGS

FIG. 1 is a developed view of core member used in an alkaline storage battery electrode according to a first embodiment of the invention.

FIG. 2 is a developed view of the core member used in an alkaline storage battery electrode according to a second embodiment of the invention.

FIG. 3 is a partially cutaway perspective view of the alkaline storage battery according to the embodiments of this invention.

FIG. 4 is a diagram for explaining a relation of sizes of the through holes of the core member in examples and comparative examples.

FIG. 5 is a diagram showing the arrangement of the through holes of the core member in an example 1 of this invention.

FIG. 6 is a diagram showing the arrangement of the through holes of the core member in an example 2 of this invention.

FIG. 7 is a diagram showing the arrangement of the through holes of the core member in an example 3 of this invention.

FIG. 8 is a diagram showing the arrangement of the through holes of the core member in an example 4 of this invention.

FIG. 9 is a diagram showing the arrangement of the through holes of the core member in an example 5 of this invention.

FIG. 10 is a diagram showing the arrangement of the through holes of the core member in an example 6 of this invention.

FIG. 11 is a diagram showing the arrangement of the through holes of the core member in an example 7 of this invention.

FIG. 12 is a diagram showing the arrangement of the through holes of the core member in an example 8 of this invention.

FIG. 13 is a diagram showing the arrangement of the through holes of the core member in an example 9 of this invention.

FIG. 14 is a diagram showing the arrangement of the through holes of the core member in a comparative example 1.

FIG. 15 is a diagram showing the arrangement of the through holes of the core member in a comparative example 2.

FIG. 16 is a diagram showing the arrangement of the through holes of the core member in a comparative example 3.

FIG. 17 is a diagram showing the arrangement of the through holes of the core member in a comparative example 4.

FIG. 18 is a characteristic diagram showing the characteristics of the internal resistance in each of the examples 1 to 4 and the comparative examples 1 to 4.

FIG. 19 is a developed view of core member used in an alkaline storage battery electrode of a related art.

### MODE FOR CARRYING OUT THE INVENTION

In the following embodiments, as examples of the configuration of the alkaline storage battery electrode and the alkaline storage battery according to the present invention, the configuration of the through holes of the core member of the electrode is mainly described.

### First Embodiment

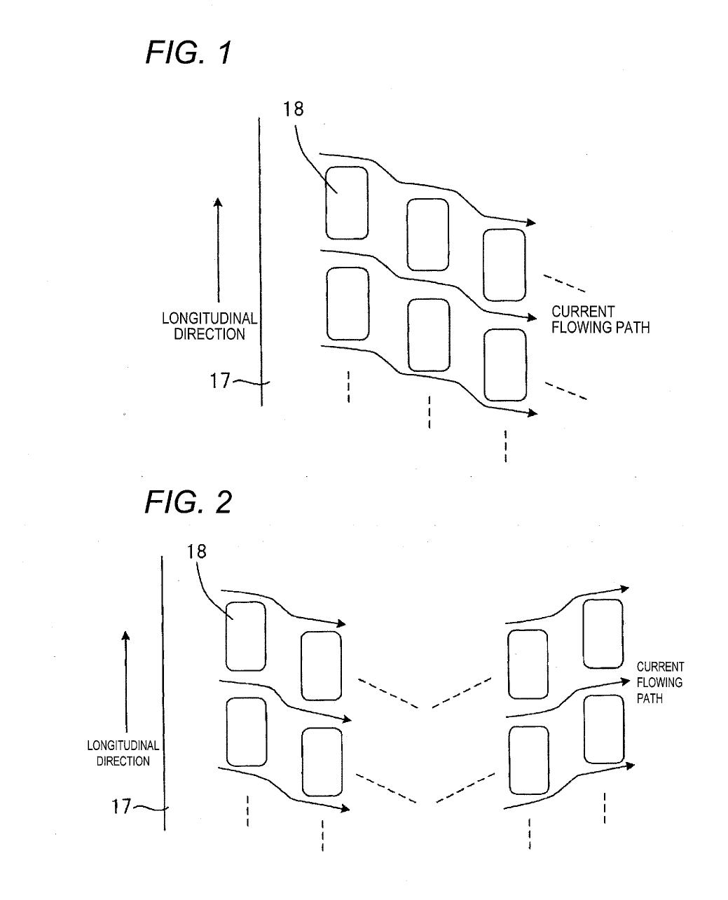

FIG. 1 is a developed view of core member 17 used in an alkaline storage battery electrode according to a first embodiment of the invention. Many substantially rectangular through holes 18 are provided in the core member 17 of a belt shape. The core member 17 is coated with paste containing active material such as hydrogen absorbing alloy thereby forming the alkaline storage battery electrode. In this embodiment, the through holes 18 are disposed linearly in parallel with the longitudinal direction of the core member 17. Each of the through holes 18 is formed in a substantially rectangular shape. Lines of the through holes 18 are arranged so as to be sequentially shifted in the longitudinal direction of the core member 17.

In the case of forming the substantially rectangular through hole of the core member, similar to the example of related art shown in FIG. 19, the through holes are generally arranged such that the adjacent lines are disposed in a staggered pattern along the longitudinal direction. However, the through holes arranged in the staggered pattern have a problem that the reaction resistance of the alkaline storage battery increases as compared with an alkaline storage battery electrode using core member having through holes each having a round shape of the related art.

This tendency becomes remarkable particularly in a case of joining a current collector plate to an end surface of a negative electrode plate. The current collector plate is jointed to the end surface of the negative electrode plate, generally, by a method in which the positive and negative electrode plates are displaced in the width direction thereof to expose the end surface at the time of spirally rolling or laminating the positive and negative electrode plates whereby the end surface serves as a core member exposing portion coated with no active material, and the current collector plate is joined to the end surface of the negative electrode plate by the resistance welding or laser welding, etc. According to this configuration, current flowing through the negative electrode plate at the time of charging or discharging is collected to the current collector plate joined to the end surface. In this case, although the current is transmitted to and received from the positive electrode plate via a separator at portions of the negative electrode plate, electrons move in a thickness direction from the surface of the negative electrode plate and arrive at the core member and then move to the current collector plate via the core member. That is, current in the core member of the negative electrode mainly flows in the width direction of the negative electrode plate.

As in the aforesaid example of the related art, in the configuration where the substantially rectangular through holes are arranged in the staggered pattern, flow of current in the width direction of the core member is interfered by the through holes. Thus, since a current flowing path of the core member becomes long in fact, the reaction resistance as the battery increases.

The inventor of the present invention earnestly investigated and found that in a case of the electrode using the core member having the substantially rectangular through holes, in the vicinity of a rolling core where the curvature becomes minimum, the active material in the vicinity of the sides in parallel with the rolling core among the four sides of the through hole is most likely to drop. The above-described example of related art has a structure that, since the positions of the sides perpendicular to the longitudinal direction of the core member coincide at every other line, the electrode is likely to be damaged by a bending stress at the time of rolling in a case of rolling the electrode by the rolling core placed in a direction perpendicular to the longitudinal direction of the core member. Thus, cracking or breakage may occur at the periphery of the sides in parallel to the rolling core in each of the through holes, which may lead to a problem that the active material drops to cause leakage defects.

In order to solve the above-described problem, in this embodiment, the positions of the through holes 18 are sequentially shifted in the longitudinal direction of the core member 17 at every line of the through holes 18. According to this configuration, since current flow in the width direction of the electrode plate is not interfered whereby the current flowing path becomes short, the reaction resistance can be equal to or smaller than that of the alkaline storage battery using the core member having the round-shaped through holes. Further, the positions of the sides of the through holes perpendicular to the longitudinal direction of the core member, which are portions where clacking or breakage at the electrode plate is likely to occur, are shifted sequentially without coinciding at two or more lines. Consequently, the electrode has the structure having tolerance for a bending stress at the time of rolling. Therefore, since the occurrence of the cracking or breakage of the electrode plate can be prevented and the dropping of the active material at the time of rolling or laminating the electrode can be suppressed, the life time of the battery can be elongated.

In this case, a displacement amount x is provided between the through holes 18 of the adjacent lines in the width direction of the core member 17. The displacement amount x is less than a half of a sum of a size “a” of the through hole 18 in the longitudinal direction of the core member and a distance “b” between the adjacent through holes 18 in the longitudinal direction of the core member 17. In other words, the displacement amount x is defined so as to satisfy a relation of (a+b)x(½)>x, that is, x/(a+b)<0.5 between the through holes 18 of the adjacent lines which are disposed linearly along the longitudinal direction so as to be in parallel to each other. Accordingly, the configuration is realized that the through holes 18 are shifted in the longitudinal direction of the core member 17 at every linear line of the through holes 18.

In the first embodiment, the displacement amount x of the through holes 18 is defined to have a displacement amount in one direction of the longitudinal direction of the core member 17. That is, as shown in an example of FIG. 1, there is an arrangement where the displacement amount is set in the lower direction in the drawing so as to shift the through holes 18 obliquely in the right downward direction. On the contrary, there may be another arrangement where the displacement amount is set in the upper direction so as to shift the through holes 18 obliquely in the right upward direction, for example.

### Second Embodiment

FIG. 2 is a developed view of core member 17 used in an alkaline storage battery electrode according to the second embodiment of the invention. The second embodiment shows an example of the configuration where the displacement amount x of the through holes 18 is set to both opposite directions in the longitudinal direction of the core member 17. In the example of FIG. 2, arrangements in which the displacement amount of the through holes 18 is set to the lower direction so as to shift obliquely to the right downward direction are repeated for a predetermined number of times, and then arrangements in which the displacement amount of the through holes 18 is set to the upper direction so as to shift obliquely to the right upward direction are repeated for a predetermined number of times. In this case, the direction of the displacement amount x of the through holes 18 in the longitudinal direction of the core member 17 is changed to the opposite direction on the way, thereby arranging the through holes 18 in a substantially V shape.

In the case where the through holes 18 are arranged so as to be shifted as in this embodiment, since a stress is generated in the width direction of the core member 17 at the time of rolling the electrode, the electrode is likely to be rolled obliquely with respect to the rolling core. As a result, a rolling misalignment of the electrode is likely to occur. Further, in the case of fabricating the negative electrode plate, when the displacement amount x of the through holes 18 is set to only one direction, the negative electrode plate may be extended eccentrically and so warped at the time of coating the core member 17 with the past of hydrogen absorbing alloy and then rolling. Thus, according to the second embodiment, since the displacement amount x of the through holes 18 is set to the both opposite directions in the longitudinal direction of the core member 17, the stress generated in the width direction of the core member 17 at the time of rolling can be reduced and so the rolling misalignment and the warp of the electrode can be suppressed.

Preferably, the displacement amount x of the through holes 18 is arranged in a manner that in the width direction of the core member 17, the repetition number of the displacement amount in the first direction along the longitudinal direction of the core member 17 is same as that in the second direction along the longitudinal direction of the core member. Since the repetition number of the displacement amount x is se to be same in each of the opposite directions along the longitudinal direction of the core member 17, the shift direction of the displacement amount x of the through holes 18 changes to the opposite direction on the way and then the position of the through hole returns to the original position. Thus, the rolling misalignment and the warp of the electrode at the time of rolling the electrode can be further suppressed.

The number of a point where the shift direction of the displacement amount x of the through holes 18 changes to the opposite direction is not limited to one and so may be plural. Accordingly, as the arrangement of the through holes 18, various kinds of modified examples such as a substantially V shape, a substantially W shape or the repetition of these shapes may be employed.

The displacement amount x of the through holes 18 may be set as a function representing the displacement amount along the longitudinal direction of the core member 17 and the function may be set to have an inflection point on the way in the width direction of the core member 17. That is, a function f (n) where the displacement amount x=f (n) may be set so as to define the displacement amount at every line of the through holes 18. In this case, n is the number of lines of the through holes 18 provided along the longitudinal direction of the core member 17, that is, the number of the lines of the openings from the one end in the width direction of the core member 17. As shown in the figure as an example, in the case of the arrangement where the displacement amount x is fixed and so the through holes shift linearly, the function representing the displacement amount becomes a linear function. In order to return the position of the through hole to the original position, the number of the inflection points is set preferably to an uneven number. For example, a secondary function type, a V-shape d or W-shaped folding type, or a quartic function type etc. may be assumed as the function. The through holes 18 can be disposed by setting the displacement amount x according to one of these functions. According to such the configuration, also the rolling misalignment of the electrode at the time of rolling the electrode can be suppressed.

Each of the first and second embodiments shows the arrangement where the displacement amounts x of the through holes 18 are constant, that is, the through holes 18 are shifted by the constant amount irrespective of the positions of the lines of the through holes 18 in the width direction of the core member 17 as shown in the drawings. However, this invention is not limited to this arrangement. For example, this invention includes an arrangement such as the secondary function type where the displacement amount x changes depending on the position of the line of the through holes 18 in the width direction of the core member 17. Similar effects can be obtained in such the arrangement where the displacement amount x changes depending on the line.

In this embodiment, the aperture ratio of the through holes 18 in the core member 17 is set to a range of 20 to 61%. In order to improve the volume ratio of the active material in the electrode, it is preferable to increase the aperture ratio of the through holes 18 in a range capable of withstanding as to the pressing of a high pressure. In view of this matter, a suitable range of the aperture ratio is 20 to 61% and more preferably 25 to 55%. The aperture ratio defined in this invention is calculated from the areas of the perforated portions as the through holes 18 in the core member 17, specifically, is calculated by removing the portions where the through holes 18 are not formed the left side in FIG. 1.

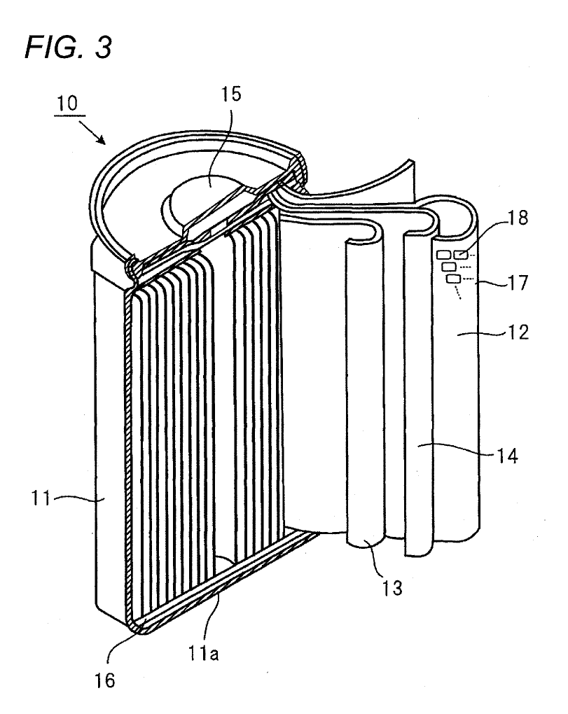

FIG. 3 is a partially cutaway perspective view of the alkaline storage battery according to the embodiment of this invention. FIG. 3 shows an example of the configuration of alkaline storage battery where the alkaline storage battery electrode containing the core member 17 according to the aforesaid embodiment is constituted as the negative electrode plate. Of course, the core member 17 according to this embodiment may also be applied to the positive electrode plate.

In the alkaline storage battery 10 such as a nickel-metal hydride storage battery, an electrode group is formed in a manner that the negative electrode plate 12 having a belt shape and the positive electrode plate 13 having a belt shape are laminated with a separator 14 being sandwiched therebetween and are spirally rolled along their longitudinal directions thereof, and the rolled electrode group is concentrically housed in a cylindrical case 11. In the electrode group, the positive and negative electrodes are rolled so as to be shifted in the width direction in a manner that the end surface of the positive electrode plate 13 is exposed at the upper portion and the end surface of the negative electrode plate 12 is exposed at the lower portion. A negative electrode current collector plate 16 is joined to the exposed end surface of the negative electrode plate 12 at the lower portion by the resistance welding. One end surface 11a of the case 11 is closed. The negative electrode current collector plate 16 joined to the end surface of the negative electrode plate 12 is made in contact with or welded to the inner surface of the closed end surface. The other end surface of the case 11 is opened. This opened opening portion is sealed by a sealing plate 15. The sealing plate 15 is made in contact with one of the side edge portions of the positive electrode plate 13, whereby the sealing plate 15 acts as the current collector portion on the positive electrode side. The case 11 is filled with an alkaline aqueous solution, as an electrolyte, which mainly contains potassium hydroxide.

The negative electrode plate 12 is configured by using, in addition to the core member 17, a hydrogen absorbing alloy as the active material in the case of the nickel-metal hydride storage battery, whilst cadmium in the case of a nickel-cadmium storage battery

The core member 17 is formed by a steel plate or a nickel plate etc. In the case of using iron as the core member 17, the surface of the iron is preferably subjected to a nickel plating so as to improve corrosion resistivity.

The opening area of each of the through holes 18 is preferably set to be 10 mm² or less in order to prevent the past coated on the core member 17 from dropping. Alternatively, each of the corner portions of the through hole 18 having a substantially rectangular shape may be cut in a round shape or subjected to a cutting process.

The positive electrode plate 13 is generally configured by filling nickel hydroxide as the active material in the core member formed by three-dimensional metal porous material such as foamed nickel. In the case of employing a mode (so-called a sinter type positive electrode) where the core member is coated with paste mainly containing nickel powder, then sintered and thereafter impregnated with nickel hydroxide as the active material, it goes without saying that the positive electrode plate 13 corresponding to the alkaline storage battery electrode according to this invention can be configured by using the core member 17 similar to that of the negative electrode plate 12 as the core member.

Although the separator 14 is not limited to particular one so long as it is used as a separator for the normal alkaline storage battery, it is preferable to use sulfonated polypropylene nonwoven fabric.

The case 11 is formed by a steel plate or a nickel plate etc. In the case of using iron as the core member 17, the surface of the iron is preferably subjected to a nickel plating so as to improve corrosion resistivity.

Hereinafter, examples of the alkaline storage battery electrode and the alkaline storage battery according to the invention will be explained.

### EXAMPLES

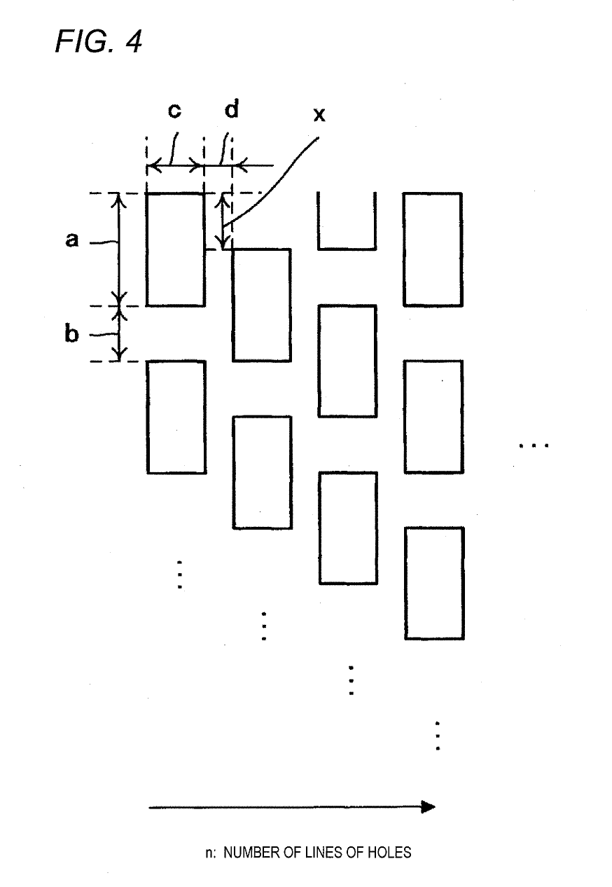

The examples contain examples 1 to 4 shown in the following table 1, examples 5 to 7 shown in the following table 2, and examples 8 to 9 shown in the following table 3. These examples will be explained also with reference to FIGS. 4 to 17 together with comparative examples 1 to 4 shown in a table 4.

FIG. 4 is a diagram for explaining a relation of sizes of the through holes of the core member in the respective examples and comparative examples. In this case, the size (size in the longitudinal direction) of the through hole in the longitudinal direction of the core member is set to be “a”, the distance (distance in the longitudinal direction) between the adjacent through holes in the longitudinal direction of the core member is set to be “b”, the size (size in the width direction) of the through hole in the width direction of the core member is set to be “c”, the distance (distance in the width direction) between the adjacent through holes in the width direction of the core member is set to be “d”, and the displacement amount of the through holes between the adjacent ones of the lines along the longitudinal direction of the core member is set to be x. Further, the number of lines of the through holes (the number of lines of the openings from the one end in the width direction of the core member) provided along the longitudinal direction of the core member is set to be n.

TABLE 1

| | Example 1 | Example 2 | Example 3 | Example 4 |
|---|---|---|---|---|
| | a = 2 mm | a = 2 mm | a = 2 mm | a = 2 mm |
| | b = 1 mm | b = 1 mm | b = 1 mm | b = 1 mm |
| | c = 1 mm | c = 1 mm | c = 1 mm | c = 1 mm |
| | d = 0.5 mm | d = 0.5 mm | d = 0.5 mm | d = 0.5 mm |
| | aperture ratio = 44.4% | aperture ratio = 44.4% | aperture ratio = 44.4% | aperture ratio = 44.4% |
| | n = 29 | n = 29 | n = 29 | n = 29 |
| | x = 0.5 | x = 1 | x = 0.2 | x = 1.3 |
| | x/(a + b) = 0.167 | x/(a + b) = 0.333 | x/(a + b) = 0.067 | x/(a + b) = 0.433 |
| Leakage Defects | Good | Good | Good | Good |
| | 0/1000 | 0/1000 | 2/1000 | 1/1000 |
| Rolling Misalignment | Good/Relatively Good | Good/Relatively Good | Good/Relatively Good | Good/Relatively Good |
| Defects | 3/1000 | 3/1000 | 1/1000 | 4/1000 |
| Internal Resistance | Good | Good | Good | Good/Relatively Good |
| Initial State | 4.0 mΩ | 4.8 mΩ | 4.5 mΩ | 5.7 mΩ |
| Cycle Life Time | Good | Good | Good | Good |
| After 500 Cycles | 4.4 mΩ | 5.1 mΩ | 5.2 mΩ | 6.2 mΩ |

### Example 1

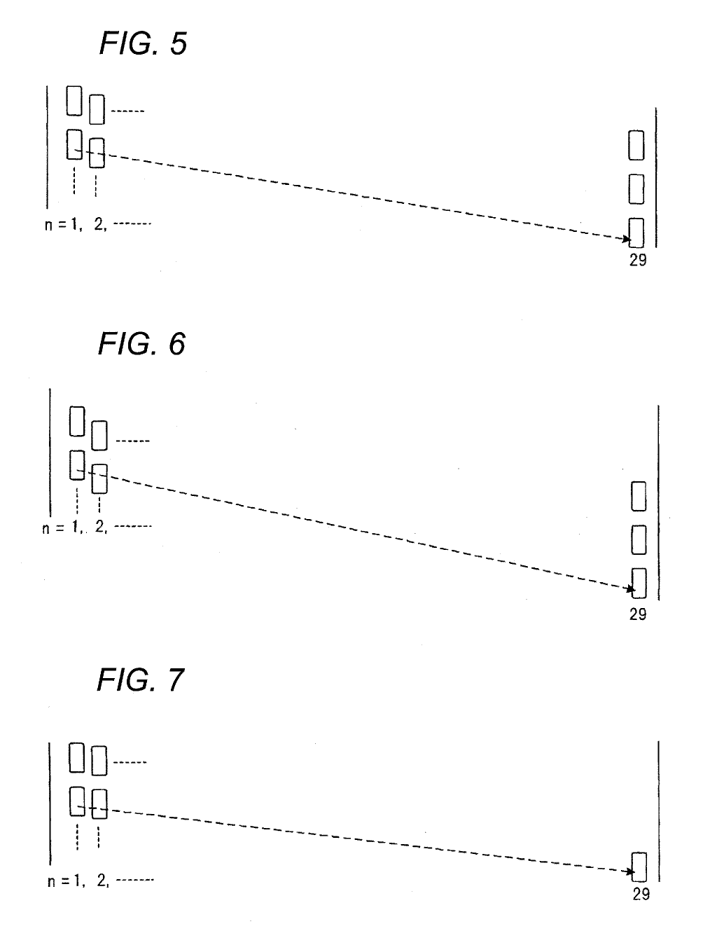

FIG. 5 is a diagram showing the arrangement of the through holes of the core member in the example 1 of this invention. As the core member 17 of the negative electrode plate 12, a nickel-plated steel plate (thickness of 60 μm) was used by perforating the through holes 18 each having the substantially rectangular shape with an opening area of 2.0 mm². The width of the core member 17 was set to 50 mm. To be concrete, as shown in FIG. 5, the through holes 18 were arranged in the core member 17 in a manner that the size “a” of the through hole in the longitudinal direction of the core member was set to 2.0 mm, the distance “b” between the adjacent through holes in the longitudinal direction of the core member was set to 1.0 mm, the size “c” of the through hole in the width direction of the core member was set to 1.0 mm, the distance “d” between the adjacent through holes in the width direction of the core member was set to 0.5 mm, and the displacement amount x of the through holes between the adjacent lines was set to 0.5 mm. The total number n of the lines of the through holes in the width direction of the core member was set to 29. In this case, the aperture ratio was 44.4%. The relation among the sizes “a”, “b” of the through holes and the displacement amount x was x/(a+b)=0.167.

The core member 17 was coated with paste which was formed by a mixture of hydrogen absorbing alloy (composition formula: MmNi_{3.55}CO_{0.75}Al_{0.3}Mn_{0.4} (Mm was a mixture of light rare earth element), crushed by a ball mill such that an average particle size thereof was about 20 μm) and a binding agent, and was dried. Thereafter, the core member was pressed by a roll press mill (linear pressure 400 t/cm) so that the total thickness thereof became 0.30 mm, and then the core member 17 was cut in a belt shape so that its major axis extended in the longitudinal direction of the core member, to thereby fabricate the negative electrode plate 12 having a theoretical capacity 10 Ah.

The negative electrode plate 12 was opposed against the belt-shaped positive electrode plate 13 (thickness 0.3 mm, theoretical capacity 6.5 Ah) formed by filling nickel hydroxide into foamed nickel, with the separator 14 formed by sulfonated polypropylene nonwoven fabric (thickness 0.2 mm) being sandwiched therebetween. Then, these plates were rolled together with the separator in a spiral form along the belt-shaped major axis by using a core rod of 5 mm and was housed within the case 11 (inner diameter 31 mm, height 63 mm). Further, an alkaline aqueous solution, as an electrolyte, which mainly contained potassium hydroxide having a specific gravity of 1.3, was filled, and then the opening portion of the case 11 was sealed by a sealing plate, to thereby fabricate a nickel-metal hydride storage battery of size D (theoretical capacity 6.5 Ah).

According to the example 1, the occurrence probability of the leakage defects was good value of 1/1000, the occurrence probability of the rolling misalignment defects was substantially good value of 3/1000, and the initial internal resistance was a low value of about 4.0 mΩ. As to the cycle life time at the end point of 500 cycles, the internal resistance was also a low value of about 4.0 mΩ which was substantially the same as the initial value. In this manner, good results was obtained as to all the characteristics.

### Example 2

FIG. 6 is a diagram showing the arrangement of the through holes of the core member in the example 2 of this invention. In the core member 17 of the negative electrode plate 12, the through holes 18 were arranged in the core member 17 in a manner that the size “a” of the through hole in the longitudinal direction of the core member was set to 2.0 mm, the distance “b” between the adjacent through holes in the longitudinal direction of the core member was set to 1.0 mm, the size “c” of the through hole in the width direction of the core member was set to 1.0 mm, the distance “d” between the adjacent through holes in the width direction of the core member was set to 0.5 mm, and the displacement amount x of the through holes between the adjacent lines was set to 1.0 mm. The total number n of the lines of the through holes in the width direction of the core member was set to 29. In this case, the aperture ratio was 44.4%. The relation among the sizes “a”, “b” of the through holes and the displacement amount x was x/(a+b)=0.333. The negative electrode plate 12 was fabricated in a manner that other configurations of this example was similar to those of the example 1.

According to the example 2, the occurrence probability of the leakage defects was good value of 1/1000, the occurrence probability of the rolling misalignment defects was substantially good value of 3/1000, and the initial internal resistance was a low value of about 4.8 mΩ. As to the cycle life time at the end point of 500 cycles, the internal resistance was also a low value of about 5.1 mΩ which was substantially the same as the initial value. In this manner, good results was obtained as to all the characteristics.

### Example 3

FIG. 7 is a diagram showing the arrangement of the through holes of the core member in the example 3 of this invention. In the core member 17 of the negative electrode plate 12, the through holes 18 were arranged in the core member 17 in a manner that the size “a” of the through hole in the longitudinal direction of the core member was set to 2.0 mm, the distance “b” between the adjacent through holes in the longitudinal direction of the core member was set to 1.0 mm, the size “c” of the through hole in the width direction of the core member was set to 1.0 mm, the distance “d” between the adjacent through holes in the width direction of the core member was set to 0.5 mm, and the displacement amount x of the through holes between the adjacent lines was set to 0.2 mm. The total number n of the lines of the through holes in the width direction of the core member was set to 29. In this case, the aperture ratio was 44.4%. The relation among the sizes “a”, “b” of the through holes and the displacement amount x was x/(a+b)=0.067. The negative electrode plate 12 was fabricated in a manner that other configurations of this example was similar to those of the example 1.

According to the example 3, the occurrence probability of the leakage defects was good value of 2/1000, the occurrence probability of the rolling misalignment defects was good value of 1/1000, and the initial internal resistance was a low value of about 4.5 mΩ. As to the cycle life time at the end point of 500 cycles, the internal resistance was also a low value of about 5.2 mΩ which was substantially the same as the initial value. In this manner, good results was obtained as to all the characteristics.

### Example 4

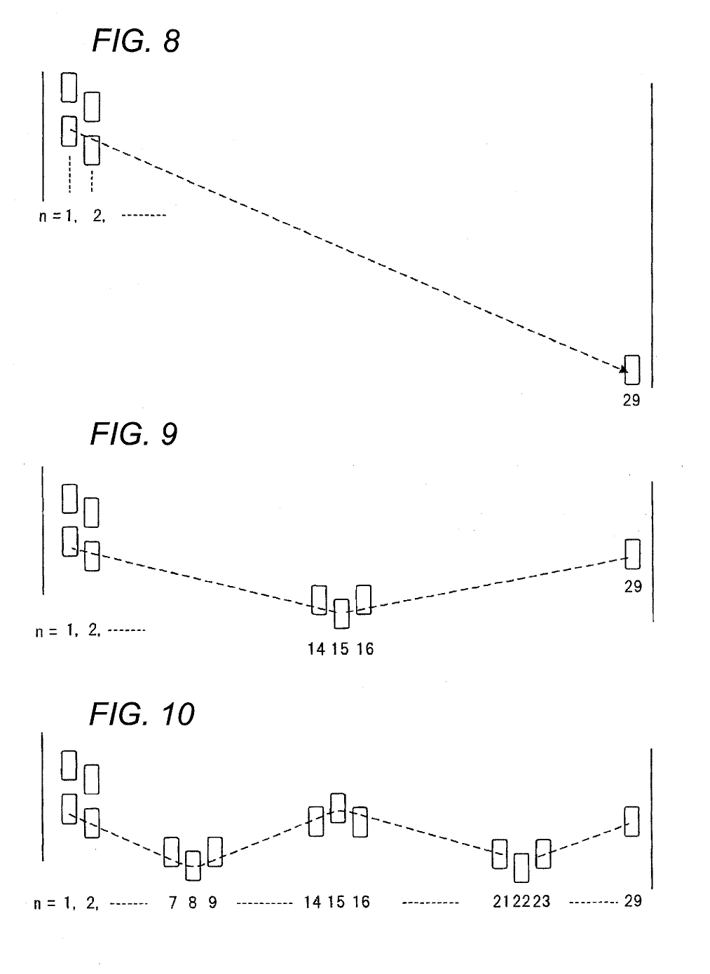

FIG. 8 is a diagram showing the arrangement of the through holes of the core member in the example 4 of this invention. In the core member 17 of the negative electrode plate 12, the through holes 18 were arranged in the core member 17 in a manner that the size “a” of the through hole in the longitudinal direction of the core member was set to 2.0 mm, the distance “b” between the adjacent through holes in the longitudinal direction of the core member was set to 1.0 mm, the size “c” of the through hole in the width direction of the core member was set to 1.0 mm, the distance “d” between the adjacent through holes in the width direction of the core member was set to 0.5 mm, and the displacement amount x of the through holes between the adjacent lines was set to 1.3 mm. The total number n of the lines of the through holes in the width direction of the core member was set to 29. In this case, the aperture ratio was 44.4%. The relation among the sizes “a”, “b” of the through holes and the displacement amount x was x/(a+b)=0.433. The negative electrode plate 12 was fabricated in a manner that other configurations of this example was similar to those of the example 1.

According to the example 4, the occurrence probability of the leakage defects was good value of 1/1000, the occurrence probability of the rolling misalignment defects was substantially good value of 4/1000, and the initial internal resistance was a relatively low value of about 5.7 mΩ. As to the cycle life time at the end point of 500 cycles, the internal resistance was also a relatively low value of about 6.2 mΩ which was substantially the same as the initial value. In this manner, good results was obtained as to all the characteristics.

TABLE 2

| | Example 5 | Example 6 | Example 7 |
|---|---|---|---|
| | a = 2 mm | a = 2 mm | a = 2 mm |
| | b = 1 mm | b = 1 mm | b = 1 mm |
| | c = 1 mm | c = 1 mm | c = 1 mm |
| | d = 0.5 mm | d = 0.5 mm | d = 0.5 mm |
| | aperture ratio = 44.4% | aperture ratio = 44.4% | aperture ratio = 44.4% |
| | n = 29 | n = 29 | n = 29 |
| | x = 1 | x = 1 | x = f(n) |
| | (lines 1-15) | (lines 1-8 and 15-22) | quadratic curve |
| | x = −1 | x = −1 | inflection point appears at n = 15, |
| | (lines 15-29) | (lines 8-15 and 22-29) | displacement amount xp |
| | x/(a + b) = 0.333 | x/(a + b) = 0.333 | between n = 1 and n = 15th is 5 mm. |
| | (lines 1-15) | (lines 1-8 and 15-22) | |
| | x/(a + b) = −0.333 | x/(a + b) = −0.333 | |
| | (lines 15-29) | (lines 8-15 and 22-29) | |
| Leakage Defects | Good | Good | Good |
| | 0/1000 | 0/1000 | 0/1000 |
| Rolling Misalignment | Good | Good | Good |
| Defects | 0/1000 | 0/1000 | 0/1000 |
| Internal Resistance | Good | Good | Good |
| Initial State | 4.9 mΩ | 5.0 mΩ | 4.7 mΩ |
| Cycle Life Time | Good | Good | Good |
| After 500 Cycles | 5.4 mΩ | 5.5 mΩ | 5.1 mΩ |

### Example 5

FIG. 9 is a diagram showing the arrangement of the through holes of the core member in the example 5 of this invention. In the core member 17 of the negative electrode plate 12, the through holes 18 were arranged in the core member 17 in a manner that the size “a” of the through hole in the longitudinal direction of the core member was set to 2.0 mm, the distance “b” between the adjacent through holes in the longitudinal direction of the core member was set to 1.0 mm, the size “c” of the through hole in the width direction of the core member was set to 1.0 mm, the distance “d” between the adjacent through holes in the width direction of the core member was set to 0.5 mm, and the displacement amount x of the through holes between the adjacent lines was set to 1.0 mm for the opening line number n=1st line to 15th line and −1.0 mm for the opening line number n=15th line to 29th line. The total number n of the lines of the through holes in the width direction of the core member was set to 29. That is, the through holes 18 were arranged in a substantially V shape in a manner that the displacement amount x of the through holes was changed to the opposite direction on the way in the width direction of the core member 17. In this case, the aperture ratio was 44.4%. The relation among the sizes “a”, “b” of the through holes and the displacement amount x was x/(a+b)=0.333 for the opening line number n=1st line to 15th line and x/(a+b)=−0.333 for the opening line number n=15th line to 29th line. The negative electrode plate 12 was fabricated in a manner that other configurations of this example was similar to those of the example 1.

According to the example 5, the occurrence probability of the leakage defects was good value of 0/1000, the occurrence probability of the rolling misalignment defects was good value of 0/1000, and the initial internal resistance was a low value of about 4.9 mΩ. As to the cycle life time at the end point of 500 cycles, the internal resistance was also a low value of about 5.4 mΩ which was substantially the same as the initial value. In this manner, good results was obtained as to all the characteristics.

In the arrangement of the through holes of the example 5, the displacement amount x may be x=0.5 mm as in the example 1. In this case, since the internal resistance becomes small as in the example 1, more preferably both the prevention of the rolling misalignment defects and the reduction of the internal resistance can be realized.

### Example 6

FIG. 10 is a diagram showing the arrangement of the through holes of the core member in the example 6 of this invention. In the core member 17 of the negative electrode plate 12, the through holes 18 were arranged in the core member 17 in a manner that the size “a” of the through hole in the longitudinal direction of the core member was set to 2.0 mm, the distance “b” between the adjacent through holes in the longitudinal direction of the core member was set to 1.0 mm, the size “c” of the through hole in the width direction of the core member was set to 1.0 mm, the distance “d” between the adjacent through holes in the width direction of the core member was set to 0.5 mm, and the displacement amount x of the through holes between the adjacent lines was set to 1.0 mm for the opening line number n=1st line to 8th line and 15th line to 22nd line and set to −1.0 mm for the opening line number n=8th line to 15th line and 22nd line to 29th line. The total number n of the lines of the through holes in the width direction of the core member was set to 29. That is, the through holes 18 were arranged in a substantially W shape in a manner that the displacement amount x of the through holes was changed to the opposite direction for plural times on the way in the width direction of the core member 17. In this case, the aperture ratio was 44.4%. The relation among the sizes “a”, “b” of the through holes and the displacement amount x was x/(a+b)=0.333 for the opening line number n=1st line to 8th line and 15th line to 22nd line and was x/(a+b)=−0.333 for the opening line number n=8th line to 15th line and 22nd line to 29th line. The negative electrode plate 12 was fabricated in a manner that other configurations of this example was similar to those of the example 1.

According to the example 6, the occurrence probability of the leakage defects was good value of 0/1000, the occurrence probability of the rolling misalignment defects was good value of 0/1000, and the initial internal resistance was a low value of about 5.0 mΩ. As to the cycle life time at the end point of 500 cycles, the internal resistance was also a low value of about 5.5 mΩ which was substantially the same as the initial value. In this manner, good results was obtained as to all the characteristics.

In the arrangement of the through holes of the example 6, the displacement amount x may be x=0.5 mm as in the example 1. In this case, since the internal resistance becomes small as in the example 1, more preferably both the prevention of the rolling misalignment defects and the reduction of the internal resistance can be realized.

### Example 7

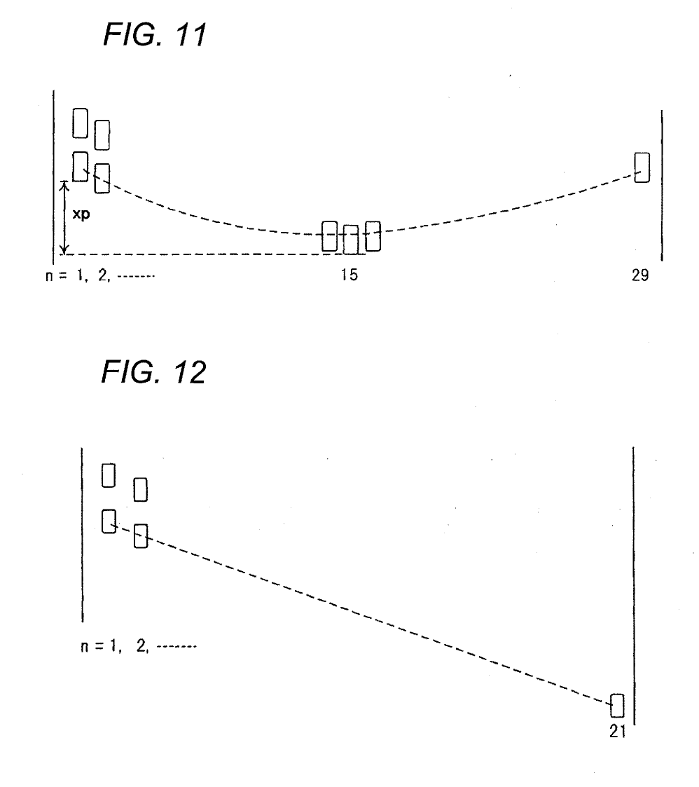

FIG. 11 is a diagram showing the arrangement of the through holes of the core member in the example 6 of this invention. In the core member 17 of the negative electrode plate 12, the through holes 18 were arranged in the core member 17 in a manner that the size “a” of the through hole in the longitudinal direction of the core member was set to 2.0 mm, the distance “b” between the adjacent through holes in the longitudinal direction of the core member was set to 1.0 mm, the size “c” of the through hole in the width direction of the core member was set to 1.0 mm, the distance “d” between the adjacent through holes in the width direction of the core member was set to 0.5 mm, and the displacement amount x of the through holes between the adjacent lines was set to form such a quadratic curve x=f (n) that an inflection point appeared at n=15th line and the displacement amount xp between n=1st line and n=15th line was 5.0 mm. The total number n of the lines of the through holes in the width direction of the core member was set to 29. That is, the through holes 18 were arranged in a manner that the displacement amount x of the through holes formed a curved shape having the function of the quadratic curve. In this case, the aperture ratio was 44.4%. The negative electrode plate 12 was fabricated in a manner that other configurations of this example was similar to those of the example 1.

According to the example 7, the occurrence probability of the leakage defects was good value of 0/1000, the occurrence probability of the rolling misalignment defects was good value of 0/1000, and the initial internal resistance was a low value of about 4.7 mΩ. As to the cycle life time at the end point of 500 cycles, the internal resistance was also a low value of about 5.1 mΩ which was substantially the same as the initial value. In this manner, good results was obtained as to all the characteristics.

In the arrangement of the through holes of the example 7, the displacement amount x may be x=0.5 mm as in the example 1. In this case, since the internal resistance becomes small as in the example 1, more preferably both the prevention of the rolling misalignment defects and the reduction of the internal resistance can be realized.

TABLE 3

| | Example 8 | Example 9 |
|---|---|---|
| | a = 1.5 mm | a = 3.8 mm |
| | b = 1.5 mm | b = 0.8 mm |
| | c = 0.8 mm | c = 1.5 mm |
| | d = 1.2 mm | d = 0.5 mm |
| | aperture ratio = 20% | aperture ratio = 61% |
| | n = 21 | n = 21 |
| | x = 1 | x = 1 |
| | x/(a + b) = 0.333 | x/(a + b) = 0.217 |
| Leakage Defects | Good | Good |
| | 0/1000 | 0/1000 |
| Rolling Misalignment | Good/Relatively Good | Good/Relatively Good |
| Defects | 3/1000 | 2/1000 |
| Internal Resistance | Good | Relatively Good |
| Initial State | 4.3 mΩ | 5.8 mΩ |
| Cycle Life Time | Relatively Good | Relatively Good |
| After 500 Cycles | 6.1 mΩ | 6.8 mΩ |

### Example 8

FIG. 12 is a diagram showing the arrangement of the through holes of the core member in the example 8 of this invention. In the core member 17 of the negative electrode plate 12, the through holes 18 were arranged in the core member 17 in a manner that the size “a” of the through hole in the longitudinal direction of the core member was set to 1.5 mm, the distance “b” between the adjacent through holes in the longitudinal direction of the core member was set to 1.5 mm, the size “c” of the through hole in the width direction of the core member was set to 0.8 mm, the distance “d” between the adjacent through holes in the width direction of the core member was set to 1.2 mm, and the displacement amount x of the through holes between the adjacent lines was set to 1.0 mm. The total number n of the lines of the through holes in the width direction of the core member was set to 21. In this case, the aperture ratio was 20.0%. The relation among the sizes “a”, “b” of the through holes and the displacement amount x was x/(a+b)=0.333. The negative electrode plate 12 was fabricated in a manner that other configurations of this example was similar to those of the example 1.

According to the example 8, the occurrence probability of the leakage defects was good value of 0/1000, the occurrence probability of the rolling misalignment defects was substantially good value of 3/1000, and the initial internal resistance was a low value of about 4.3 mΩ. As to the cycle life time at the end point of 500 cycles, the internal resistance was also a relatively low value of about 6.1 mΩ which was substantially the same as the initial value. In this manner, good results was obtained as to all the characteristics. Although the thickness of the electrode increased by 10%, there arose no practical problem.

### Example 9

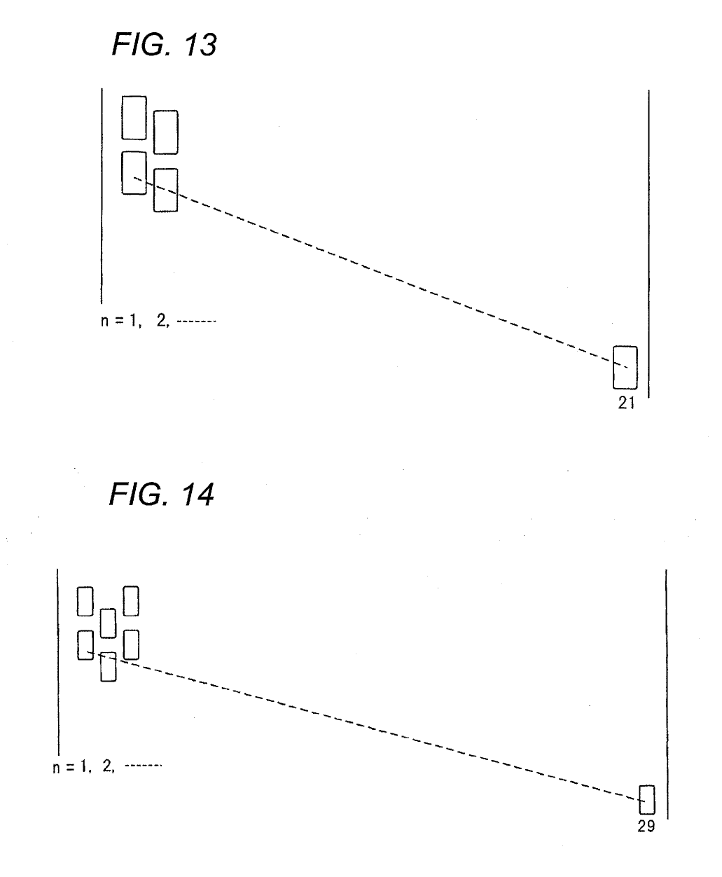

FIG. 13 is a diagram showing the arrangement of the through holes of the core member in the example 9 of this invention. In the core member 17 of the negative electrode plate 12, the through holes 18 were arranged in the core member 17 in a manner that the size “a” of the through hole in the longitudinal direction of the core member was set to 3.8 mm, the distance “b” between the adjacent through holes in the longitudinal direction of the core member was set to 0.8 mm, the size “c” of the through hole in the width direction of the core member was set to 1.5 mm, the distance “d” between the adjacent through holes in the width direction of the core member was set to 0.5 mm, and the displacement amount x of the through holes between the adjacent lines was set to 1.0 mm. The total number n of the lines of the through holes in the width direction of the core member was set to 21. In this case, the aperture ratio was 61.0%. The relation among the sizes “a”, “b” of the through holes and the displacement amount x was x/(a+b)=0.217. The negative electrode plate 12 was fabricated in a manner that other configurations of this example was similar to those of the example 1.

According to the example 9, the occurrence probability of the leakage defects was good value of 0/1000, the occurrence probability of the rolling misalignment defects was good value of 2/1000, and the initial internal resistance was a relatively low value of about 5.8 mΩ. As to the cycle life time at the end point of 500 cycles, the internal resistance was also a relatively low value of about 6.8 mΩ which was substantially the same as the initial value. In this manner, good results was obtained as to all the characteristics. Although small rolling misalignment occurred after the rolling, there arose no practical problem.

TABLE 4

| | Comparative | Comparative | Comparative | Comparative |
|---|---|---|---|---|
| | Example 1 | Example 2 | Example 3 | Example 4 |
| | a = 2 mm | a = 2 mm | a = 2 mm | a = 2 mm |
| | b = 1 mm | b = 1 mm | b = 1 mm | b = 1 mm |
| | c = 1 mm | c = 1 mm | c = 1 mm | c = 1 mm |
| | d = 0.5 mm | d = 0.5 mm | d = 0.5 mm | d = 0.5 mm |
| | aperture ratio = 44.4% | aperture ratio = 44.4% | aperture ratio = 44.4% | aperture ratio = 44.4% |
| | n = 29 | n = 29 | n = 29 | n = 29 |
| | x = 1.5 | x = 0 | x = 1.4 | x = 0.1 |
| | x/(a + b) = 0.500 | x/(a + b) = 0.000 | x/(a + b) = 0.467 | x/(a + b) = 0.033 |
| Leakage Defects | Good | Bad | Good | Bad |
| | 0/1000 | 12/1000 | 0/1000 | 10/1000 |
| Rolling Misalignment | Good/Relatively Good | Good/Relatively Good | Good/Relatively Good | Good/Relatively Good |
| Defects | 4/1000 | 3/1000 | 3/1000 | 2/1000 |
| Internal Resistance | Bad | Good | Bad | Good |
| Initial State | 9.2 mΩ | 4.9 mΩ | 7.9 mΩ | 4.7 mΩ |
| Cycle Life Time | Bad | Bad | Bad | Bad |
| After 500 Cycles | 11.5 mΩ | 12.0 mΩ | 8.3 mΩ | 9.2 mΩ |

### Comparative Example 1

FIG. 14 is a diagram showing the arrangement of the through holes of the core member in the comparative example 1. In the core member of the negative electrode plate, the through holes 18 were arranged in the core member in a manner that the size “a” of the through hole in the longitudinal direction of the core member was set to 2.0 mm, the distance “b” between the adjacent through holes in the longitudinal direction of the core member was set to 1.0 mm, the size “c” of the through hole in the width direction of the core member was set to 1.0 mm, the distance “d” between the adjacent through holes in the width direction of the core member was set to 0.5 mm, and the displacement amount x of the through holes between the adjacent lines was set to 1.5 mm. The total number n of the lines of the through holes in the width direction of the core member was set to 29. In this case, the aperture ratio was 44.4%. The relation among the sizes “a”, “b” of the through holes and the displacement amount x was x/(a+b)=0.500. The arrangement of the through holes in this comparative example 1 is similar to that of the through holes 58 of the core member 57 of the example of the related art shown in FIG. 19 and is an example where the through holes were disposed in a staggered pattern. The negative electrode plate 12 was fabricated in a manner that other configurations of this comparative example was similar to those of the example 1.

According to the comparative example 1, the occurrence probability of the leakage defects was good value of 0/1000, the occurrence probability of the rolling misalignment defects was substantially good value of 4/1000, but the initial internal resistance was a high level of about 9.2 mΩ. As to the cycle life time at the end point of 500 cycles, the internal resistance was also a high level of about 11.5 mΩ.

### Comparative Example 2

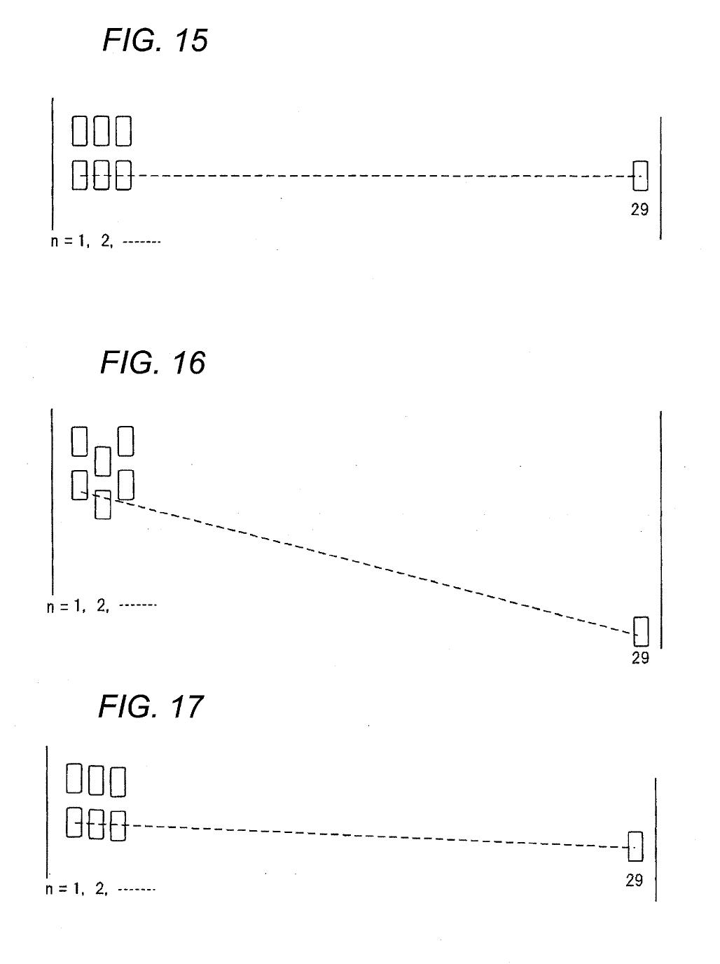

FIG. 15 is a diagram showing the arrangement of the through holes of the core member in the comparative example 2. In the core member of the negative electrode plate, the through holes 18 were arranged in the core member in a manner that the size “a” of the through hole in the longitudinal direction of the core member was set to 2.0 mm, the distance “b” between the adjacent through holes in the longitudinal direction of the core member was set to 1.0 mm, the size “c” of the through hole in the width direction of the core member was set to 1.0 mm, the distance “d” between the adjacent through holes in the width direction of the core member was set to 0.5 mm, and the displacement amount x of the through holes between the adjacent lines was set to 0.0 mm. The total number n of the lines of the through holes in the width direction of the core member was set to 29. In this case, the aperture ratio was 44.4%. The relation among the sizes “a”, “b” of the through holes and the displacement amount x was x/(a+b)=0.000. This comparative example 2 is an example where the through holes were disposed in a staggered pattern. The negative electrode plate 12 was fabricated in a manner that other configurations of this comparative example was similar to those of the example 1.

According to the comparative example 1, the occurrence probability of the leakage defects was substantially good value of 3/1000, but the occurrence probability of the rolling misalignment defects was bad value of 12/1000. Further, although the initial internal resistance was a low value of about 4.9 mΩ, as to the cycle life time at the end point of 500 cycles, the internal resistance was a high level of about 12.0 mΩ.

### Comparative Example 3

FIG. 16 is a diagram showing the arrangement of the through holes of the core member in the comparative example 3. In the core member of the negative electrode plate, the through holes 18 were arranged in the core member in a manner that the size “a” of the through hole in the longitudinal direction of the core member was set to 2.0 mm, the distance “b” between the adjacent through holes in the longitudinal direction of the core member was set to 1.0 mm, the size “c” of the through hole in the width direction of the core member was set to 1.0 mm, the distance “d” between the adjacent through holes in the width direction of the core member was set to 0.5 mm, and the displacement amount x of the through holes between the adjacent lines was set to 1.4 mm. The total number n of the lines of the through holes in the width direction of the core member was set to 29. In this case, the aperture ratio was 44.4%. The relation among the sizes “a”, “b” of the through holes and the displacement amount x was x/(a+b)=0.467. The arrangement of the through holes in this comparative example 3 is an example where the characteristic differences from the examples were verified by slightly reducing the size of the displacement amount x than the comparative example 1. The negative electrode plate 12 was fabricated in a manner that other configurations of this comparative example was similar to those of the example 1.

According to the comparative example 3, the occurrence probability of the leakage defects was good value of 0/1000, the occurrence probability of the rolling misalignment defects was substantially good value of 3/1000, but the initial internal resistance was a high level of about 7.9 mΩ. As to the cycle life time at the end point of 500 cycles, the internal resistance was also a high level of about 8.3 mΩ.

### Comparative Example 4

FIG. 17 is a diagram showing the arrangement of the through holes of the core member in the comparative example 4. In the core member of the negative electrode plate, the through holes 18 were arranged in the core member in a manner that the size “a” of the through hole in the longitudinal direction of the core member was set to 2.0 mm, the distance “b” between the adjacent through holes in the longitudinal direction of the core member was set to 1.0 mm, the size “c” of the through hole in the width direction of the core member was set to 1.0 mm, the distance “d” between the adjacent through holes in the width direction of the core member was set to 0.5 mm, and the displacement amount x of the through holes between the adjacent lines was set to 0.1 mm. The total number n of the lines of the through holes in the width direction of the core member was set to 29. In this case, the aperture ratio was 44.4%. The relation among the sizes “a”, “b” of the through holes and the displacement amount x was x/(a+b)=0.033. The arrangement of the through holes in this comparative example 4 is an example where the characteristic differences from the examples were verified by slightly increasing the size of the displacement amount x than the comparative example 2. The negative electrode plate 12 was fabricated in a manner that other configurations of this comparative example was similar to those of the example 1.

According to the comparative example 4, the occurrence probability of the rolling misalignment defects was substantially good value of 2/1000, but the occurrence probability of the leakage defects was bad value of 10/1000. Further, although the initial internal resistance was a low value of about 4.7 mΩ, as to the cycle life time at the end point of 500 cycles, the internal resistance was a high level of about 9.2 mΩ.

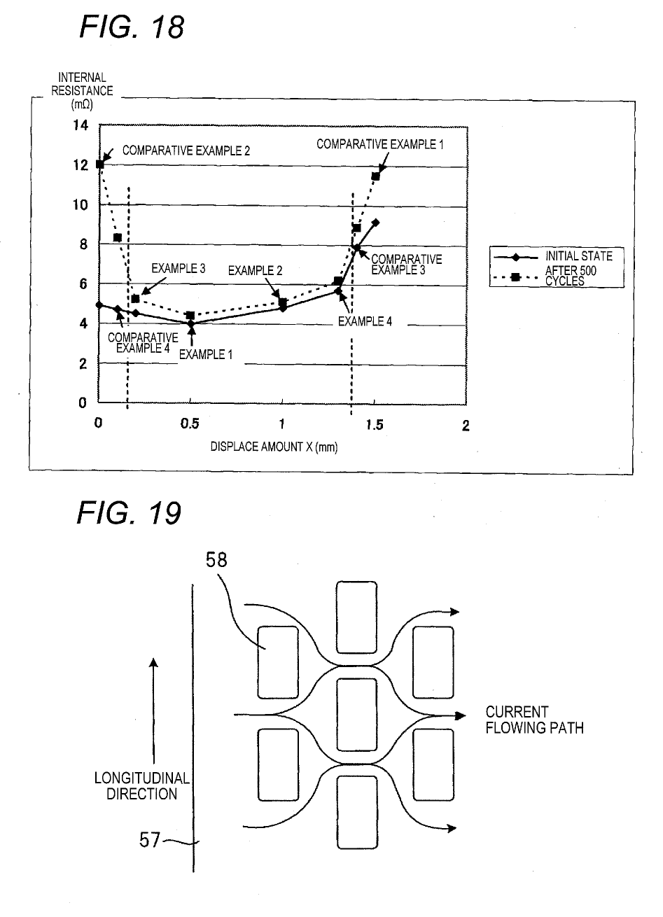

FIG. 18 is a characteristic diagram showing the characteristics of the internal resistance in each of the examples 1 to 4 and the comparative examples 1 to 4. In FIG. 18, an abscissa is the displacement amount x of the through holes in each configuration of the respective examples and respective comparative examples and an ordinate is the internal resistance in each of the respective examples and respective comparative examples. As to the internal resistance, and ▪ in the figure represent a value in the initial state and a value at the end point of 500 cycles, respectively. As clear from this characteristic diagram, when compared between the examples 1 to 4 and the comparative examples 1 to 4, the displacement amount x is preferably set in a range of 0.2 mm≦x≦1.3 mm in the longitudinal direction of the core member with respect to a value of (a+b)×(½)=1.5 mm as to the sizes of the through holes. Concerning the value of x/(a+b), it is preferable to set in a range of 0.067≦x/(a+b)≦0.433. In this range, since each of the initial internal resistance and the initial internal resistance at the end point of 500 cycles was low, good characteristics could be obtained. Further, since the occurrence probability of each of the leakage defects and the rolling misalignment defects was low, both the improvement of the electric characteristics of the electrode and the prevention of the defects could be realized.

According to the aforesaid results, it was proved that the core member 17 of the alkaline storage battery electrode of the invention can satisfy all of the prevention of the leakage defects and the rolling misalignment defects, the reduction of the internal resistance and the elongation of the life time when the through holes 18 each having the substantially rectangular shape provided at the materoal 17 are arranged in a manner that the through holes 18 are shifted at each of the linear lines of the through holes 18 each disposed along the longitudinal direction of the core member 17. Further, it was proved that good results in a range of 20 to 61% was obtained as to the aperture ratio of the through holes 18.

As described above, in the configurations of the embodiments and the examples according to this invention, the through holes each having the substantially rectangular shape are arranged so as to be shifted in the longitudinal direction of the core member at each of the lines of the through holes, in the conductive core member of the alkaline storage battery electrode. Thus, the positions of the through holes in the longitudinal direction of the core member do not coincide between the adjacent lines and between the every other lines, but coincide between every three or more lines. When the displacement amount in the longitudinal direction of the core member in the state where the through holes are shifted is recognized as a phase difference of the arrangement of the through holes, the phase becomes the same with a period of three or more lines. As a result, when the electrode is rolled around the rolling core which is placed in a direction perpendicular to the longitudinal direction of the core member, since it is possible to ensure the intensity at the peripheries of the sides of the respective through holes in parallel to the rolling core (perpendicular to the longitudinal direction of the core member) where the electrode plate is likely to be broken, the generation of crack or breakage of the electrode plate can be prevented. Accordingly, in particular in the rolled-type electrode structure, the dropping of the active material can be suppressed, the occurrence of leakage defects can be prevented and the life time of the battery can be elongated. The similar effects can be obtained in the case where the configuration of each of these embodiments and the examples is applied to the lamination-type electrode structure.

Further, since an increase of the length of the current flowing paths of the core member can be suppressed, the flowing of current in the width direction of the alkaline storage battery electrode can be made smooth and hence the internal resistance of the alkaline storage battery can be reduced. Furthermore, since the through holes each having the rectangular shape are disposed and the aperture ratio thereof is set in the range of 20 to 61%, the volume ratio of the active material can be improved by utilizing the core member which is durable as to the pressing process with a high pressure for the alkaline storage battery electrode. Thus, since the reaction resistance of the alkaline storage battery can be reduced, the alkaline storage battery having a high energy density and a high power can be realized.

Furthermore, the displacement amounts at the time of arranging the through holes in a shifted manner are set in a manner that the through holes have the displacement amounts in the opposite directions along the longitudinal direction of the core member so as to have the inflection point on the way. in the width direction of the core member. Thus, the rolling misalignment of the electrode can be suppressed and the defective ratio at the time of manufacturing the batteries can be reduced.

This invention contains a range where persons skilled in the art perform various changes and modifications based on the description of the specification and the well known techniques without departing from the gist and range of this invention, and such the range is contained in the scope for protection. Further, the respective constituent elements in the aforesaid embodiments may be arbitrarily combined in a range not departing from the gist of this invention.

This application is based on Japanese Patent Application (Japanese Patent Application No. 2010-090455) filed on Apr. 9, 2010 and Japanese Patent Application (Japanese Patent Application No. 2010-282221) filed on Dec. 17, 2010, the contents of which is incorporated herein by reference.

### INDUSTRIAL APPLICABILITY

This invention has the effects that the volume ratio of the active material in the alkaline storage battery electrode can be improved and the reactive resistance of the battery can be reduced to thereby realize the battery of a high power, and further dropping of the active material can be suppressed at the time of rolling or laminating the electrode to thereby realize the battery of a long life time. Thus, this invention can be the constituent element of the alkaline storage battery realizing high power and long life time. Accordingly, this invention is highly usable and effective as a power supply such as an electric car using a plurality of alkaline storage batteries as the battery.

### DESCRIPTION OF REFERENCE SKINS

10 Alkaline Storage Battery
11 Case
12 Negative Electrode Plate
13 Positive Electrode Plate
14 Separator
15 Sealing Plate
16 Negative Electrode Current Collector Plate
17 Core member
18 Through Hole

1. An alkaline storage battery electrode comprising a conductive core member as a current collector,
wherein a plurality of through holes are formed in the core member so as to be arranged linearly in parallel with a longitudinal direction of the core member,
wherein each of the through holes has a substantially rectangular shape,
wherein the through holes are arranged so as to be shifted in the longitudinal direction of the core member at each of lines of the linearly-arranged through holes, and
wherein a displacement amount between the through holes of adjacent lines in a width direction is less than a half of a sum of a size of the through hole in the longitudinal direction of the core member and a distance between the adjacent through holes in the longitudinal direction of the core member.

2. The alkaline storage battery electrode according to claim 1,
wherein the displacement amounts of the through holes have displacement amounts in one direction of the longitudinal direction of the core member.

3. The alkaline storage battery electrode according to claim 1,
wherein the displacement amounts of the through holes have displacement amounts in both directions of the longitudinal direction of the core member.

4. The alkaline storage battery electrode according to claim 3,
wherein the through holes are arranged such that in the width direction of the core member, the number of the displacement amount in a first direction along the longitudinal direction of the core member is the same as that in a second direction along the longitudinal direction of the core member.

5. The alkaline storage battery electrode according to claim 3,
wherein the through holes are arranged such that a function representing the displacement amount along the longitudinal direction of the core member has an inflection point on a way in the width direction of the core member.

6. The alkaline storage battery electrode according to claim 1,
wherein the displacement amounts of the through holes in the longitudinal direction of the core member are constant irrespective of positions of the lines of the through holes in the width direction of the core member.

7. The alkaline storage battery electrode according to claim 1,
wherein the displacement amount of the through holes in the longitudinal direction of the core member changes depending on a position of the line of the through holes in the width direction of the core member.

8. The alkaline storage battery electrode according to claim 1,
wherein 0.067≦x/(a+b)≦0.433 is satisfied,
where “a” is a size of the through hole in the longitudinal direction of the core member; “b” is a distance between the adjacent through holes; and “x” is the displacement amount of the through holes.

9. The alkaline storage battery electrode according to claim 1,
wherein an aperture ratio of the through holes is set in a range of 20 to 61%.

10. An alkaline storage battery comprising:
an electrode group in which a negative electrode plate and a positive electrode plate with a separator being sandwiched therebetween are cylindrically rolled; and
an electrolyte,
wherein the alkaline storage battery electrode according to claim 1 is used as the positive electrode plate or the negative electrode plate.

11. An alkaline storage battery comprising:
an electrode group in which a negative electrode plate and a positive electrode plate with a separator being sandwiched therebetween are cylindrically laminated; and
an electrolyte,
wherein the alkaline storage battery electrode according to claim 1 is used as the positive electrode plate or the negative electrode plate.
